(19) United States
(12) Patent Application Publication
(10) Pub. No.: US 2026/0112875 A1
(43) Pub. Date: Apr. 23, 2026

(54) SYSTEM AND METHOD FOR A HEIGHT ADJUSTABLE UTILITY RISER ASSEMBLY

(71) Applicant: Champion Fiberglass, Inc., Spring, TX (US)

(72) Inventors: Matthew Dale BROCATO, Deer Park, TX (US); Timothy Ryan DEASY, Houston, TX (US); Matthew Marek FREDERICKS, Saint Paul, MN (US); Scott Lewis PATCHAN, Pinehurst, TX (US); Matthew Dean VAUGHT, Catawba, NC (US)

(73) Assignee: Champion Fiberglass, Inc., Spring, TX (US)

(21) Appl. No.: 19/358,579

(22) Filed: Oct. 15, 2025

Related U.S. Application Data
(60) Provisional application No. 63/710,387, filed on Oct. 22, 2024.

(51) Int. Cl. H02G 3/00

(52) U.S. Cl. CPC H02G 3/263

(57) ABSTRACT

A height adjustable utility riser assembly slidable and expandable conduits move between a contracted or retracted position and an expanded position to allow varied lengths of the riser assembly for initial mechanical connection with an electrical or communication box. An elastomer seal between the riser assembly conduits provides a slidable seal therebetween. An engineered maximum expansion indicator marking, integral with the height adjustable utility riser assembly, indicates the maximum expansion of the riser assembly to maintain the structural integrity of the installed utility riser assembly and the slidable seal therein.

A method for installing the height adjustable utility riser assembly rising from below ground or soil comprises the steps of aligning the height adjustable utility riser assembly below a box, and expanding the riser assembly slidable sleeve conduit from the contracted or retracted position to the expanded position for mechanical connection with a box while slidably sealing the riser assembly but not expanding the sleeve conduit beyond the maximum expansion indicator marking. Advantageously, after connecting the utility riser assembly between the box and another underground conduit, the slidable seal allows the riser assembly to retract and expand to accommodate movement after installation. The position of the maximum expansion indicator marking is engineered to anticipate expansion after installation to maintain the structural integrity of the installed riser assembly and the slidable seal therein.

### CROSS-REFERENCE TO RELATED APPLICATIONS

This application claims the benefit of U.S. Provisional Application No. 63/710,387 filed Oct. 22, 2024, which application is hereby incorporated by reference for all purposes in its entirety.

### BACKGROUND OF THE INVENTION

### 1. Field of the Invention

This invention generally relates to a utility riser assembly and installation of a utility riser assembly to connect an underground conduit to a box, such as an electrical panel or meter box or a communication box.

### 2. Description of the Related Art

A utility riser fabricated from fiberglass offers lightweight, corrosion resistance and low coefficient of friction when installing electrical cable to a panel or meter box or communication cable to a communication box. A utility riser fabricated from a one-piece fiberglass conduit can be made with different combinations of connectors, fittings, and tangent lengths to meet installation situations. A utility riser fabricated from the lightweight one-piece fiberglass conduit contributes to some installation ease, savings, safety, corrosion resistance to many chemicals, and cable fault resistance. A fiberglass utility riser will not melt or weld the wire to the inside of the riser under fault conditions, and further provides durability, ultraviolet “UV” resistance, one of the lowest coefficients of friction of any in-market product, high memory to retain its shape after impact or compression, and can withstand extreme conditions and temperatures. Champion Fiberglass, Inc. of Houston, Texas presently provides a one-piece utility riser UR, as shown in FIG. 1, fabricated from fiberglass.

A utility riser fabricated from fiberglass provides corrosion-resistant protection for underground utility cabling where it emerges from the ground or soil GS. A fiberglass utility riser eliminates the labor and material costs commonly associated with wrapping a galvanized rigid metal tubing “GRC” riser with costly non-corrosive tape. The lightweight and inexpensive cost as well as the labor installation savings has made a utility riser fabricated from fiberglass desirable in the marketplace.

A utility riser fabricated from fiberglass can use a standard PVC sleeve coupling and PVC adapter transitions if the underground conduit is fabricated from PVC. Iron Pipe Size “IPS” fiberglass conduit sizing system is the most frequently used international sizing system for conduits. IPS fiberglass conduit can easily be used with standard pipe clamps as the conduit is the same “OD” (outside diameter) as PVC and GRC conduits. IPS conduit also has a larger inside diameter “ID” than tubular type conduit allowing for more cable fill area. SW, MW and HW IPS conduits sized ¾″ to 1½″ can be used with the straight socket connection, while SW, MW and HW conduit sizes 2″ to 8″ are typically used with the interference joint connection. A gasket joint connection is available for all conduit sizes of SW, MW and HW.

Installation of a one-piece utility riser UR fabricated from fiberglass, PVC or GRC has been performed as shown in FIGS. 2A and 2B. If the riser UR conduit is not properly measured to the box B, such as a panel or meter box secured on a building wall W, then the conduit could be too short as shown in FIG. 2A. The height of the utility riser UR (not including the threaded portion of the male connector MC) can be measured from the finished grade G to the bottom of the box B. If the one-piece riser UR is too long, such as the utility riser UR shown in FIG. 2B, it is cut off to a measured length for final connection with the box B. The one-piece conduit utility riser UR could be initially provided with or without a male adapter or connector MC. The threaded male adapter or connector MC in FIG. 2B would be cut off along with the undesired portion of the conduit. A new threaded male adapter or connector MC would then need to be bonded with the cut utility riser UR conduit. The bonded male adapter or connector MC would be positioned into the bottom opening BO of the box B to make the final connection into electrical panel or meter box, or communication box. The utility riser UR is then connected with the box B with a threadable lock ring LR on the inside of the box B.

U.S. Pat. No. 4,861,942 to Moran proposes an adjustable utility riser assembly for an electrical cable fabricated from rigid conduits. As best shown in the '942 Moran Patent FIGS. 1 to 3, the utility riser assembly includes first and second rigid conduits having a telescoping or sliding interconnection in an enlarged diameter lower end of the upper conduit. The upper end of the upper conduit is connected by a threaded fitting to a meter box and the lower end of the lower conduit extends below grade to receive an electrical cable. The '942 Moran Patent proposes solving the problem of strain on the threaded fitting connection to the meter box by the settling of the ground or soil, and/or thermal expansion using the telescoping or sliding interconnection. See the '942 Moran Patent, col. 1, Ins. 44 to 65, and col. 3, Ins. 45 to 55.

U.S. Pat. No. 7,550,669 B2 to Rizzuto proposes a fitting for slip fit adjustment of conduits from an electric service box on a building to an underground electric service line to allow for subsidence of the ground level to reduce excessive force on the service box when the conduits are not in alignment. As shown in FIGS. 3A, 3B, and 3C, the '669 Rizzuto Patent proposes a circumferential resilient ring within the opening in the lower end of the upper conduit adapted to surround the lower conduit positioned in the lower end of the upper conduit. The upper conduit is proposed to be a resilient ring between the two conduits through which the lower conduit may slide both during installation and in case of tension caused by subsequent ground movement. The '669 Rizzuto Patent, distinguishing its utility riser assembly from the '942 Moran Patent utility riser assembly, proposes the outer circumference of the lower conduit being less than the inner circumference of the upper conduit to such an extent, in combination with the resilient ring, that the lower conduit can assume an angular position with respect to the upper conduit position when partially contained therein. The '669 Rizzuto Patent proposes that the ring has sufficient resiliency within the upper conduit lower end to allow variations of the angle of position of the lower conduit within the upper conduit, such as shown in FIGS. 3A, 3B, and 3C.

U.S. Pat. No. 5,973,264 to O'Connor proposes an electrical service riser that includes an elongated conduit that is movable between a raised operating position (FIG. 1) and a retracted transport position (FIG. 2). When in the retracted position (FIG. 2), the riser is proposed to be transported from site to site. A slip type expansion fitting is proposed about the substantially linear conduit to prevent the conduit from falling in a housing opening when the conduit is in its raised operating position (FIG. 1). The riser includes a meter fitting/disconnect that allows the riser to be used with underground utility company power lines. See the '264 O'Connor Patent, col. 4, In. 47 to col. 5, In. 16.

U.S. Pat. No. 2,100,796 to Church proposes a pipe coupler for a pipe, without threads on the end of the pipe, with electrical wires therein. In particular, the '796 Church Patent proposes a moisture-tight seal, using a sealing ring, so that if the pipe is connected with an electrical box, moisture will not enter into the box.

U.S. Pat. Nos. 2,100,796; 4,861,942; 5,973,264; and 7,550,669 B2 are incorporated herein for all purposes.

There has been a long-felt need in the industry for a height adjustable utility riser assembly system, method of installation, and apparatus that would eliminate the above steps of measuring, cutting and bonding when installing a utility riser assembly on-site that provides a maximum expansion indicator marking system to protect a slidable seal and maintains the structural integrity of the riser assembly during and after installation.

### BRIEF SUMMARY OF THE INVENTION

A system configured for use with an electrical cable panel or a meter box or a communication cable, e.g. fiber optic, box positioned above ground comprises a height adjustable utility riser assembly having a maximum expansion indicator marking system to protect a slidable seal and maintain the structural integrity of the riser assembly during and after installation. The electrical or communication cable running thru the utility riser assembly is configured for connection with components within the box. The height adjustable riser assembly moves between a retracted position and an expanded position to allow varied lengths of the riser assembly for, among other benefits, initial mechanical connection with the box during installation.

The slidable seal within the height adjustable utility riser assembly of the present disclosure advantageously excludes undesirable pests, including insects and other bugs, and undesirable substances, such as growing plants, such as vines, and other foreign substances, into the utility riser assembly. Advantageously, an engineered maximum expansion indicator marking system, integral with the height adjustable utility riser assembly, indicates the maximum expansion of the riser assembly to maintain the structural integrity of the installed height adjustable utility riser assembly and the slidable seal therein during and after installation.

A method for installing the height adjustable utility riser assembly rising from below ground comprises the steps of positioning the utility riser assembly below the electrical or communication box and expanding the riser assembly sleeve conduit from the contracted or retracted position to the expanded position for mechanical connection with a box. The mechanical connection is made while slidably sealing the riser assembly without expanding the sleeve conduit beyond the maximum expansion indicator marking. While the present disclosure solves the long-felt need and problem in the industry of eliminating on-site measuring, cutting, and bonding during installing, after connecting the riser assembly between the box and another underground conduit, the riser assembly can retract and expand to accommodate subsequent movement after installation. The movement could result from temperature changes, and/or ground or soil settlement after installation and/or the subsequent expansion and contraction of soils, such as clays. The position of the maximum expansion indicator marking on the utility riser assembly is engineered to anticipate expansion of the riser assembly after installation to maintain the structural integrity of the installed riser assembly and the slidable seal therein.

### BRIEF DESCRIPTION OF THE DRAWINGS

So that the manner in which the above recited features of the present invention can be understood in detail, a more particular description of the invention, briefly summarized above, may be had by reference to the disclosed embodiments, some of which are illustrated in the appended drawings. It is to be noted, however, that the appended drawings herein illustrate only typical embodiments of this invention and is therefore not to be considered limiting of its scope, for the invention may be used in other equally effective embodiments.

FIG. 1 is an elevational side view of a one-piece utility riser fabricated from fiberglass conduit having connectors on each of its ends.

FIG. 2A is an elevational view of a one-piece utility riser installed in the ground or soil and aligned with an electrical panel or meter box or a communication box where the one-piece utility riser is too short to make a mechanical connection with the box.

FIG. 2B is an elevational view of a one-piece utility riser installed in the ground or soil and, while aligned with the electrical panel or meter box or a communication box, where the utility riser is too long so the riser will need to be measured, cut, and a male adapter or connector bonded with the one-piece conduit to make a mechanical connection with a box.

FIG. 3 is an elevational view of the height adjustable utility riser assembly of the present disclosure in the contracted or retracted position with the sleeve conduit illustrated in section view to better disclose the elbow conduit therein and the male connector fixed in the end of the sleeve conduit, a dimension A of the length of the sleeve conduit and a dimension C of the length of the height adjustable utility riser assembly in the contracted or retracted position are illustrated.

FIG. 4 is an elevational view of the height adjustable utility riser assembly of the present disclosure in its maximum expanded position with the sleeve conduit illustrated in section view to better disclose the elbow conduit therein and the male connector fixed in the end of the sleeve conduit, a dimension D of the length of the height adjustable utility riser assembly in the maximum expanded position so as to reveal the maximum expansion indicator marking.

FIG. 5 is an elevational side view of the height adjustable utility riser assembly of the present disclosure in the retracted position similar to FIG. 3.

FIG. 6 is an elevational side view of the height adjustable utility riser assembly of the present disclosure in its maximum expanded position similar to FIG. 4 so as to reveal the maximum expansion indicator marking.

FIG. 7 is a detail view of the indicated section 7 of the height adjustable utility riser assembly of FIG. 3 to better disclose the elbow conduit with an encircling maximum expansion indicator marking thereon in relation to the groove therein adjacent to the end of the elbow conduit with an elastomer O-ring seal disposed in the groove, and a cable (not shown in FIG. 3) is illustrated running thru both the sleeve conduit and the elbow conduit.

FIG. 8 is a detail view of the indicated section 8 of the height adjustable utility riser assembly of FIG. 4 to better disclose the sleeve conduit in the maximum expanded position so as to reveal an encircling maximum expansion indicator marking on the elbow conduit, a dimension B of the length from the encircling maximum expansion indicator marking to the elastomer O-ring seal in the elbow conduit encircling groove is illustrated, and a cable (not shown in FIG. 4) is illustrated running thru both the sleeve conduit and the elbow conduit.

FIG. 8A is a section view taken along 8A-8A of FIG. 8 to better disclose the clearance of the inwardly facing surface of the sleeve conduit relative to the slidable elastomer O-ring seal in the elbow conduit encircling groove, and a cable is illustrated coaxially positioned (though the cable is not contemplated to always be in this axial position) with the sleeve conduit, the O-ring seal, and the elbow conduit.

FIG. 9 is a detail view of the indicated section 9 of the height adjustable utility riser assembly of FIG. 4 to better disclose the outwardly facing threaded male connector fixed with the end of the sleeve conduit and to further disclose a circular rubber gasket disposed between the end shoulder of the sleeve conduit and the bottom of a box, a stainless steel lock ring is illustrated threaded with the outwardly facing threads of the male connector to connect the sleeve conduit of the height adjustable utility riser assembly within the bottom opening of the box, and a cable (not shown in FIG. 4) is illustrated connected with electrical or communication components in the box.

FIG. 10 is an elevational side view illustrating the installing method step of aligning the height adjustable utility riser assembly of the present disclosure with an opening in the bottom of an electrical or communication box for installing the height adjustable utility riser assembly rising from below the ground or soil and configured to receive a cable running within the height adjustable utility riser assembly to be positioned for connection with the electrical or communication components in a box positioned above the surface of the ground or soil on a wall of a building.

FIG. 11 is an elevational side view, the installing method step, after connection of the cable with the electrical or communication components has been made, of expanding the height adjustable utility riser assembly sleeve conduit of the present disclosure from its contracted or retracted position to an expanded position for mechanical connection of the height adjustable utility riser assembly to a box as best shown in FIG. 9.

FIG. 12 is an elevational side view of the height adjustable utility riser assembly of the present disclosure installed with a box, at an alternative height other than FIG. 10 or 11, where the sleeve conduit is not expanded to its maximum expanded position so the maximum expansion indicator marking on the elbow conduit is not revealed.

FIG. 13 is an elevational side view of the height adjustable utility riser assembly of the present disclosure installed with a box, at yet another alternative height other than FIG. 10, 11, or 12, where the sleeve conduit is expanded to its maximum expanded position to reveal the maximum expansion indicator marking on the elbow conduit.

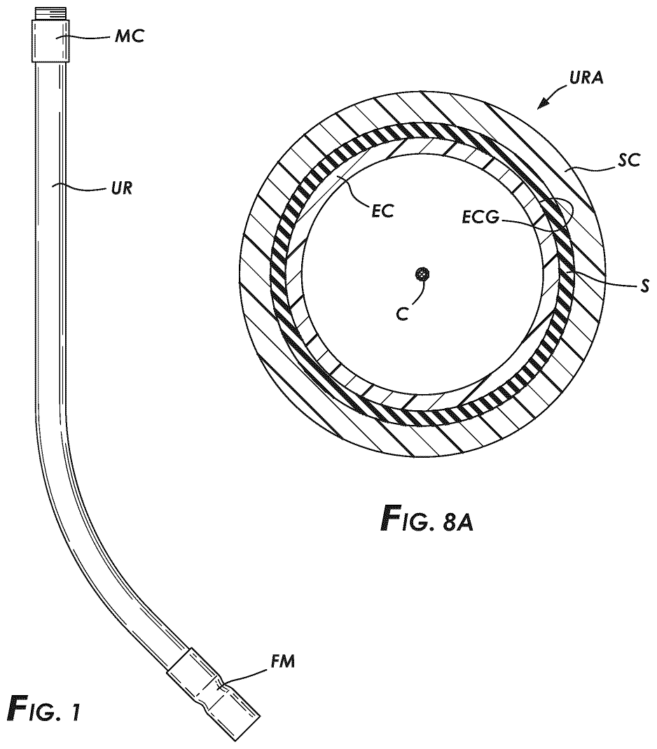

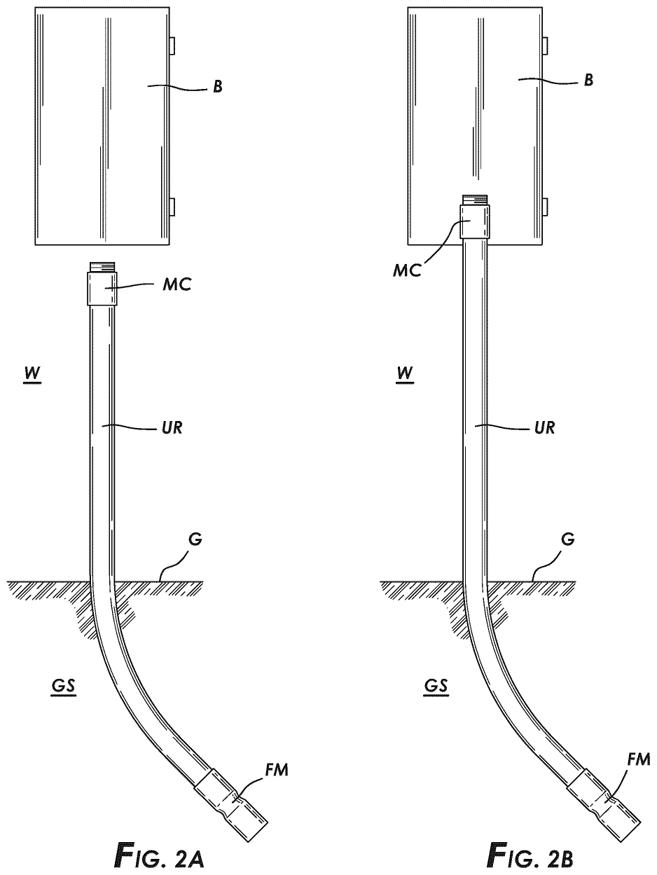

### DETAILED DESCRIPTION OF THE INVENTION

Specific embodiments of the present invention will now be described in detail with reference to the accompanying FIGS. Like elements in the various FIGS. are denoted by like reference numerals for consistency. Further, in the following detailed description of embodiments of the present invention, numerous specific details are set forth to provide a more thorough understanding of the present invention. In other instances, well-known features have not been described in detail to avoid obscuring the description of embodiments of the present invention.

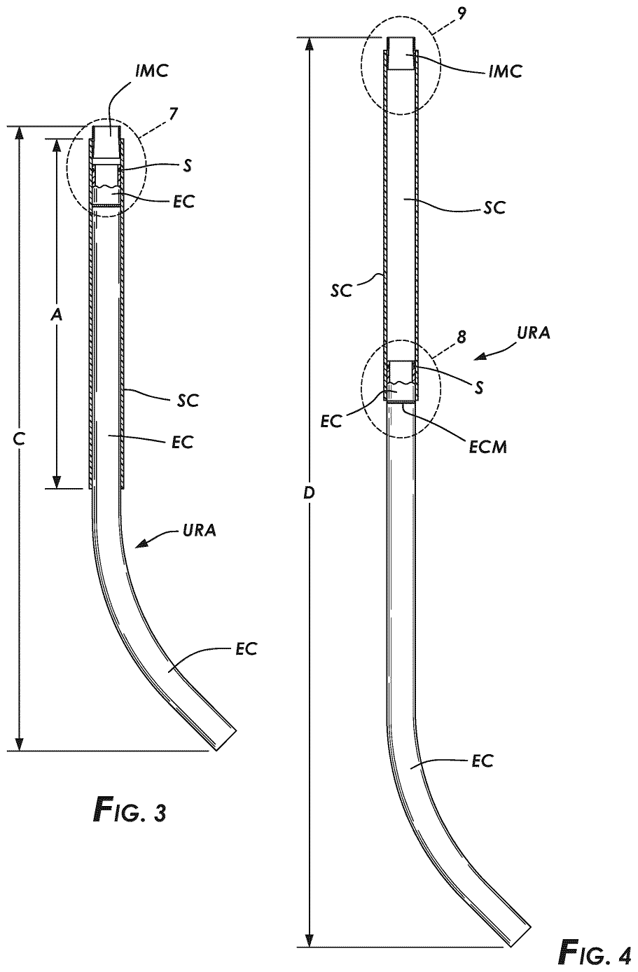

Generally, the system of the present disclosure is configured for use with a box B, such as an electrical panel or meter box or a communication box, positioned above ground on a wall W of a building, and comprises an utility riser assembly, generally indicated at URA, having slidable and expandable conduits SC, EC. A cable C, such as an electrical cable or a fiber optic communication cable is positioned in the riser assembly URA, is configured for connection with components COM in the electrical panel or meter box, or a communication box. The utility riser assembly URA slidable and expandable conduits SC, EC are configured to move between a contracted or retracted position (FIGS. 3, 5, 7, and 10), expanded position (FIGS. 4, 6, 8, 8A, 9, 11, 12, and 13), and a maximum expansion position (FIGS. 4, 6, 8, 8A, and 13) to allow varied lengths of said riser assembly URA for mechanical connection with a box B. An O-ring seal S, between said riser assembly URA slidable and expandable conduits SC, EC, provides a slidable seal therebetween. The height adjustable riser assembly URA is contemplated to be stored and transported in the contracted or retracted position to save space.

Preferably, the utility riser assembly URA is fabricated from fiberglass but other materials, such as PVC or GRC, may be used with the present disclosure. The seal S is preferably an O-ring fabricated from an elastomer, but other seals and materials could be used. A cable C runs inside said sealed riser assembly URA from below ground to inside a box B. An outwardly facing threaded male connector IMC fixedly assembled with the sleeve conduit SC of the riser assembly URA provides mechanical connection with a box B. An end connector FM for connection with another underground or below ground conduit BGC is provided on an end of the elbow conduit EC of the riser assembly URA. When the connectors IMC, FM are connected, the riser assembly URA, after installation, can retract and expand to accommodate temperature change, ground or soil GS movement, and other movement of the riser assembly URA. For example, ground or soil GS movement could result from settlement of soils after installation and/or the subsequent expansion and contraction of soils, such as clays.

Therefore, the utility riser assembly URA slidable and expandable conduits SC, EC not only allow installation of the riser assembly URA without measuring, cutting, or bonding a riser assembly to size relative to a box B thereby saving labor and material, but accommodates subsequent temperature change, ground or soil GS movement, and other movement of the riser assembly URA of the slidable and sealable riser assembly URA. The elbow conduit EC is configured to transition from below ground GS to above ground, and the sleeve conduit SC is configured to be expandable relative to said elbow portion EC for mechanical connection with a box B. Furthermore, the elbow conduit EC has a maximum expansion indicator marking ECM, such yellow paint encircling the elbow conduit EC thereon, with its position engineered to indicate the maximum expansion of the sleeve conduit SC relative to the elbow conduit EC when installed. It is to be understood the maximum expansion indicator marking ECM could be a non-encircling line, an image and/or a printed message or warning, such as “Do not expand beyond this marking.” Other varied markings are contemplated. The seal S is positioned in a groove ECG in the elbow conduit EC and is both disposed between the riser assembly URA conduits SC, EC to provide a slidable seal therebetween, and between the marking ECM and the end of the elbow conduit EC.

FIG. 3 is an elevational view of the height adjustable utility riser assembly URA of the present disclosure in the contracted or retracted position with the sleeve conduit SC in section view to better disclose the elbow conduit EC therein and the male connector IMC fixed in the end of the sleeve conduit SC. As will be discussed and disclosed below in detail, a dimension A of the length of the sleeve conduit SC and a dimension C of the length of the height adjustable utility riser assembly URA in a contracted or retracted position are provided.

FIG. 4 is an elevational view of the height adjustable utility riser assembly URA of the present disclosure in its maximum expanded position with the sleeve conduit SC in section view to better disclose the elbow conduit EC therein and the male connector IMC fixed in the end of the sleeve conduit SC. As will be discussed and disclosed below in detail, a dimension D of the length of the height adjustable utility riser assembly URA in a maximum expanded position so as to reveal the maximum expansion indicator marking is provided.

FIG. 5 is an elevational side view of the height adjustable utility riser assembly URA of the present disclosure in the retracted position similar to FIG. 3.

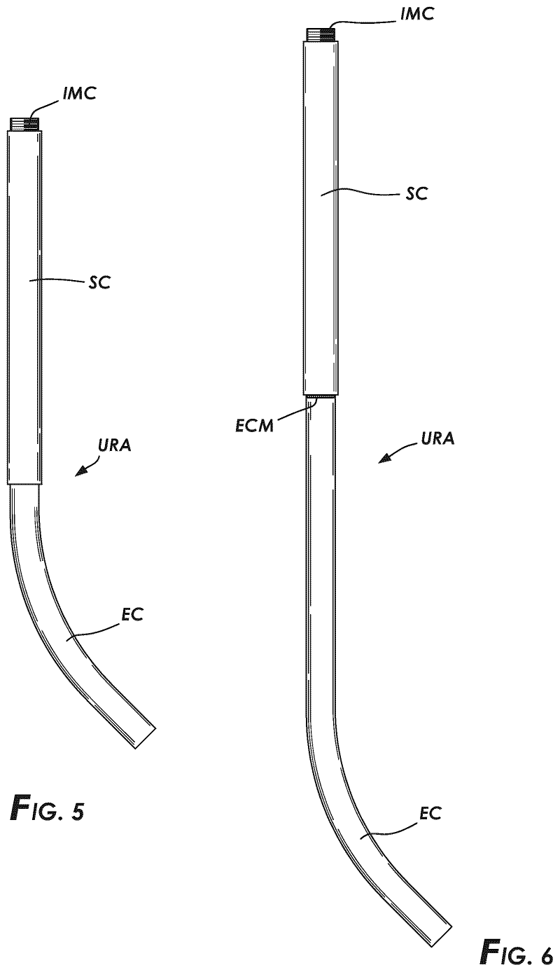

FIG. 6 is an elevational side view of the height adjustable utility riser assembly URA of the present disclosure in its maximum expanded position similar to FIG. 4 so as to reveal the maximum expansion indicator marking.

FIG. 7 is a detail view of the indicated section 7 of the height adjustable utility riser assembly of FIG. 3 to better disclose the elbow conduit EC with an encircling maximum expansion indicator marking ECM thereon in relation to the groove ECG therein adjacent to the end of the elbow conduit EC with an elastomer O-ring seal S disposed in the groove ECG, and a cable C (not shown in FIG. 3) running thru both the sleeve conduit SC and the elbow conduit EC.

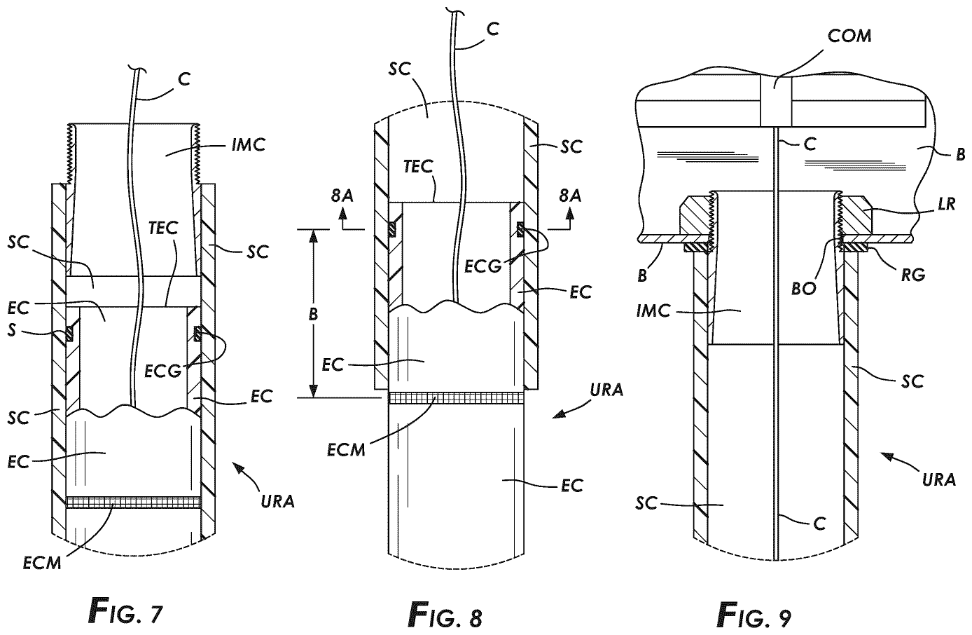

FIG. 8 is a detail view of the indicated section 8 of the height adjustable utility riser assembly of FIG. 4 to better disclose the sleeve conduit SC in the maximum expanded position so as to reveal an encircling maximum expansion indicator marking ECM on the elbow conduit EC. As will be discussed and disclosed below in detail, a dimension B of the length from the encircling maximum expansion indicator marking ECM to the elastomer O-ring seal S in the elbow conduit EC encircling groove ECG is provided, and a cable C (not shown in FIG. 4) is running thru both the sleeve conduit SC and the elbow conduit EC.

FIG. 8A is a section view taken along 8A-8A of FIG. 8 to better disclose the clearance of the inwardly facing surface of the sleeve conduit SC relative to the slidable elastomer O-ring S seal in an elbow conduit EC encircling groove ECG, and a cable C coaxially positioned (though the cable is not contemplated to always be in this axial position) with the sleeve conduit SC, the O-ring seal S, and the elbow conduit EC.

FIG. 9 is a detail view of the indicated section 9 of the height adjustable utility riser assembly URA of FIG. 4 to better disclose the outwardly facing threaded male connector ICM fixed with the end of the sleeve conduit SC and to further disclose a circular rubber gasket RG disposed between the end shoulder of the sleeve conduit SC and the bottom of the box B. A stainless steel lock ring LR is illustrated threaded with the outwardly facing threads of the male connector IMC to connect the sleeve conduit SC of the height adjustable utility riser assembly URA within the bottom opening BO of the box B, and a cable (not shown in FIG. 4) is connected with an electrical or communication components COM in the box B.

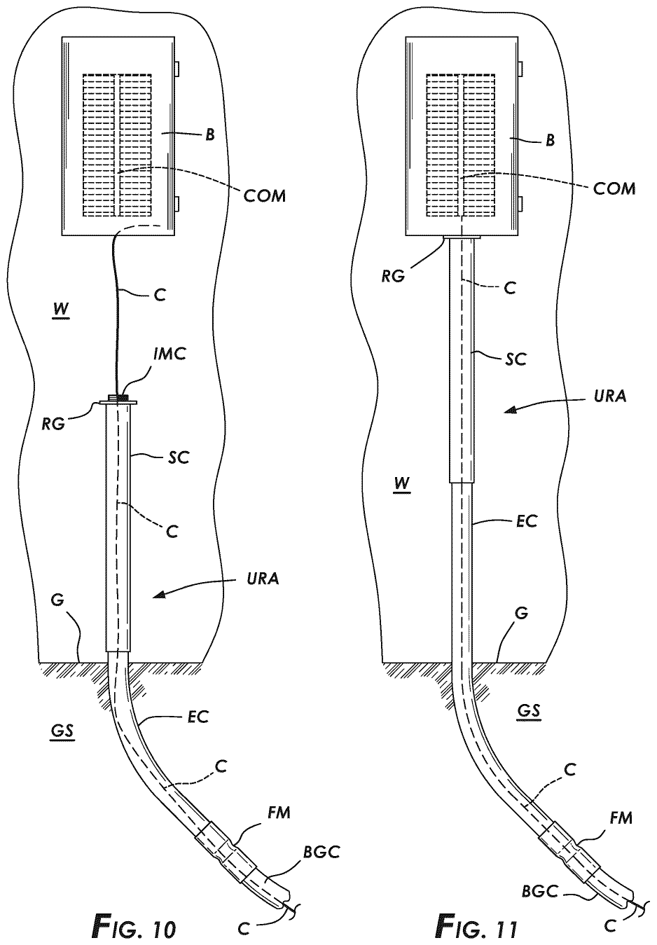

FIG. 10 is an elevational side view of the installing method step of aligning the height adjustable utility riser assembly URA of the present disclosure with in the bottom opening BO of an electrical or communication box B for installing the height adjustable utility riser assembly URA rising from below the ground or soil GS. The riser assembly is configured to receive a cable C running within the height adjustable utility riser assembly URA to be positioned for connection with the electrical or communication components COM in a box B positioned above the surface of the ground or soil GS on a wall W of a building.

In FIG. 11, the installing method step, after connection of the cable C with the electrical or communication components COM has been made, of expanding the height adjustable utility riser assembly URA sleeve conduit SC of the present disclosure from its contracted or retracted position to an expanded position for mechanical connection of the height adjustable utility riser assembly URA to a box B as best shown in FIG. 9 is disclosed.

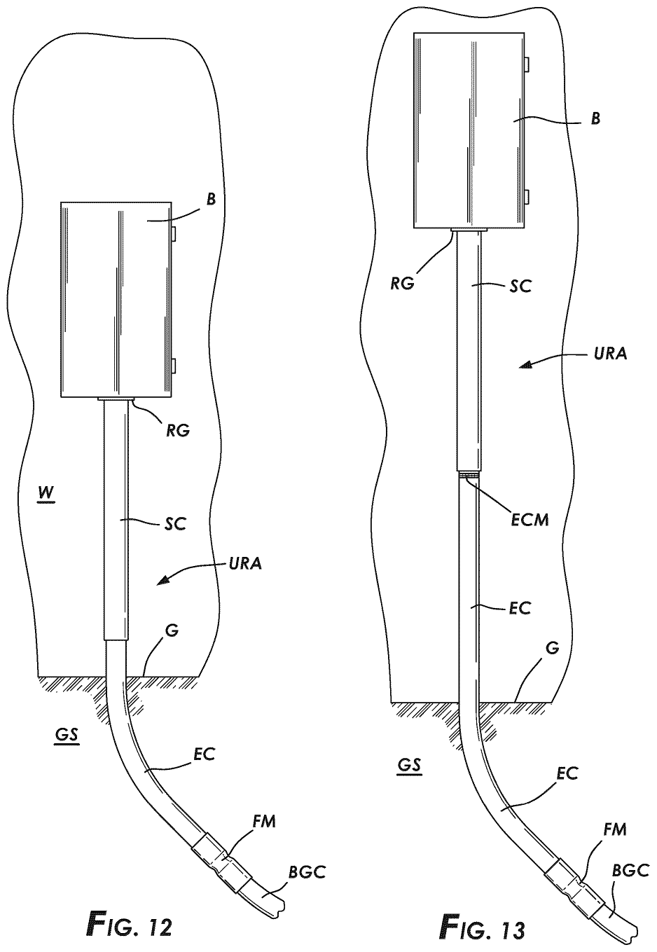

FIG. 12 is an elevational side view of the height adjustable utility riser assembly URA of the present disclosure installed with a box B, at an alternative height other than FIG. 10 or 11, where the sleeve conduit SC is not expanded to its maximum expanded position so the maximum expansion indicator marking ECM on the elbow conduit EC is not revealed.

FIG. 13 is an elevational side view of the height adjustable utility riser assembly URA of the present disclosure installed with a box B, at yet another alternative height other than FIG. 10, 11, or 12, where the sleeve conduit SC is expanded to its maximum expanded position to reveal the maximum expansion indicator marking ECM on the elbow conduit EC.

### Method of Use

The method of use of the height adjustable utility riser assembly URA of the present disclosure is described below.

First, the fiberglass sleeve conduit SC of the riser assembly URA is aligned under the bottom opening BO of the box B so that the male connector IMC can be raised to be received thru the bottom opening BO inside of the box B while the O-ring seal S provides moisture resistance inside the height adjustable utility riser assembly URA.

As shown in the FIGS., the utility riser assembly URA rising from below ground or soil GS is configured to receive a cable C for connection with components COM in a box B positioned above ground on a wall W of a building. After the riser assembly URA slidable and expandable conduits SC, EC are aligned below the bottom opening BO of a box B, the riser assembly URA slidable sleeve conduit SC is moved from a contracted or retracted position to an expanded position for mechanical connection with the box B. The elbow conduit EC has a maximum expansion indicator marking ECM thereon engineered to indicate the maximum expansion of the sleeve conduit SC relative to said elbow conduit EC. During the step of expanding the riser assembly URA, seal S slidably seals the riser assembly URA. Cable C can be pulled inside the slidably sealed riser assembly URA from below ground to inside the box B for connection. An outwardly facing threaded end connector IMC fixedly positioned with the sleeve conduit SC mechanically connects the riser assembly URA with the box B. An end connector FM on the riser assembly URA elbow conduit EC connects the riser assembly with another underground or below ground conduit BGC as is known in the industry.

Advantageously, after installing the utility riser assembly URA, including connecting both of riser assembly URA ends with connectors IMC, FM, the height adjustable riser assembly URA allows the riser assembly URA to contract or retract and expand to accommodate temperature changes, ground or soil GS movement, and other movement of the riser assembly URA. For example, ground or soil GS movement could result from settlement of soils after installation and/or the subsequent expansion and contraction of soils, such as clays.

### The Preferred Embodiment of the Height Adjustable Utility Riser Assembly of the Present Disclosure

While it is contemplated that the present disclosure could be used with conduits fabricated with other materials, such as PVC SCH 40 and 80, galvanized rigid steel, PVC coated steel, or aluminum, some of the commercially valuable features of the preferred height adjustable utility riser assembly URA of the present disclosure comprise the following:

A height adjustable utility riser assembly URA allows for expansion and contraction or retraction before installation, during installation, and after installation. Before installation, the utility riser assembly URA can be stored and transported in its contracted or retracted position to save on space. During installation, the utility riser assembly URA eliminates measuring, cutting, and/or bonding to provide a safer installation environment and to save both labor hours and material costs for installation of a riser assembly URA for a cable C to a box B, such as an electrical panel and meter box or to a communication box. After installation, the height adjustability of the riser assembly URA allows for expansion and contraction or retraction due to temperature changes, ground/soil settling, and ground/soil freeze/thaw cycles while the O-ring seal S continues to provide a slidable seal for moisture resistance therein. The preferred embodiment fiberglass utility riser assembly URA is operable in at least a temperature range from −40 degrees F. to +230 degrees F. (−40 degrees Celsius to +110 degrees Celsius). The slidable seal S integral with the height adjustable utility riser assembly URA of the present disclosure excludes undesirable pests, including insects and bugs, and undesirable substances, such as growing plants, such as vines, and other foreign substances. An engineered maximum expansion indicator marking ECM is provided with the height adjustable utility riser assembly URA to indicate the maximum expansion of utility riser assembly URA for both during installation and after installation to maintain the structural integrity of the installed utility riser assembly URA and the slidable seal S therein.

The preferred utility riser assembly URA is fabricated from fiberglass so as to provide the benefits of Ultraviolet “UV” and corrosion resistant, high strength, nonmetallic, durable, high memory to retain its shape after impact or compression, and non-conductive protection for installed power and communication cables, even vertically, for safety and a lower total cost of ownership. Preferably the fiberglass conduit used in the height adjustable utility riser assembly URA is Underwriters Laboratories “UL” 2515 listable for above ground use, CSA listable per CSA—22.2 No. 211.3-96 standard, listable in Article 12-200 of the Canadian Electrical Code “CEC” as a Rigid Reinforced Thermosetting Resin Conduit “RTRC” conduit, and listable in the National Electrical Code “NEC” Article 355 as a RTRC.

The preferred fiberglass height adjustable utility riser assembly URA is fabricated from lightweight above ground or below ground conduit to provide ease of handling in the field while providing a low coefficient of friction and low to zero burn-through when pulling wire or cable. Also, the preferred fiberglass utility riser assembly URA will not melt or weld the wire or cable C to the inside of either the sleeve conduit SC or elbow conduit EC under fault conditions.

The preferred fiberglass height adjustable utility riser assembly URA reduces burn-through, which in turn minimizes conduit, particularly elbow conduit EC, repairs to maintain the integrity of the electrical or communication system.

While it is contemplated that “off the shelf” height adjustable utility riser assemblies URA will be manufactured and available in inventory, a preferred fiberglass height adjustable utility riser assembly URA can be custom made and sized to the order and specification of an electrical contractor/electrical engineer/customer including specific transitions/fittings/connectors e.g., PVC couplers, PVC stubs, fiberglass or PVC male connectors IMC or female connectors FM or adapters, etc. Also, an electrical contractor/electrical engineer/customer can specify the angle and radius of the elbow conduit EC of the height adjustable utility riser assembly URA other than those shown in the FIGS.

Some “off the shelf” utility riser assemblies URA could include the below dimensions A, B, C, and D, as shown in the FIGS. 3, 4, and 8, that include the engineered maximum expansion indicator marking ECM position of the present disclosure.

Iron Pipe Size “IPS” nominal 2½-inch outside diameter

| | Measurement | | | |
|---|---|---|---|---|
| | Metric System | | English System | |
| A. Length of the sleeve conduit SC. | 0.8763 | meters | 34.50 | inches |
| B. Length from the maximum expansion | 0.0762 | meters | 3 | inches |
| indicator marking ECM, such as a yellow | | | | |
| line, on the elbow conduit EC to the O-ring | | | | |
| seal S (i.e., the engineered 4 inch distance | | | | |
| from the yellow line/marking ECM on the | | | | |
| elbow conduit EC to the top of the elbow | | | | |
| conduit TEC minus 1 inch from the top of | | | | |
| the elbow conduit TEC to the O-ring seal | | | | |
| S). | | | | |
| C. Length of the riser assembly URA fully | 1.5399 | meters | 60.625 | inches |
| contracted or retracted. | | | | |
| D. Length of the riser assembly URA fully | 2.264 | meters | 89.125 | inches |
| expanded to reveal the maximum expansion | | | | |
| indicator marking ECM, i.e., yellow line. | | | | |

Iron Pipe Size “IPS” nominal 3-inch outside diameter

| | Measurement | | | |
|---|---|---|---|---|
| | Metric System | | English System | |
| A. Length of the sleeve conduit SC. | 0.6604 | meters | 26 | inches |
| B. Length from the maximum expansion | 0.0762 | meters | 3 | inches |
| indicator marking ECM, such as yellow | | | | |
| line, on the elbow conduit EC to the O-ring | | | | |
| seal S (i.e., the engineered 4 inch distance | | | | |
| from the yellow line/marking ECM on the | | | | |
| elbow conduit EC to the top of the elbow | | | | |
| conduit TEC minus 1 inch from the top of | | | | |
| the elbow conduit TEC to the O-ring seal | | | | |
| S). | | | | |
| C. Length of the riser assembly URA fully | 1.3399 | meters | 52.75 | inches |
| contracted or retracted. | | | | |
| D. Length of the riser assembly URA fully | 1.8225 | meters | 71.75 | inches |
| expanded to reveal the maximum expansion | | | | |
| indicator marking ECM, i.e., yellow line. | | | | |

Iron Pipe Size “IPS” nominal 4-inch outside diameter

| | Measurement | | | |
|---|---|---|---|---|
| | Metric System | | English System | |
| A. Length of the sleeve conduit SC. | 0.5842 | meters | 23 | inches |
| B. Length from the maximum expansion | 0.0762 | meters | 3 | inches |
| indicator marking ECM, such as yellow | | | | |
| line, on the elbow conduit EC to the O-ring | | | | |
| seal S (i.e., the engineered 4 inch distance | | | | |
| from the yellow line/marking ECM on the | | | | |
| elbow conduit EC to the top of the elbow | | | | |
| conduit TEC minus 1 inch from the top of | | | | |
| the elbow conduit TEC to the O-ring seal | | | | |
| S). | | | | |
| C. Length of the riser assembly URA fully | 1.2541 | meters | 49.375 | inches |
| contracted or retracted. | | | | |
| D. Length of the riser assembly URA fully | 1.6351 | meters | 64.375 | inches |
| expanded to reveal the maximum expansion | | | | |
| indicator marking ECM, i.e., yellow line. | | | | |

The above “off the shelf” utility riser assembly URA charts are for Iron Pipe Size “IPS” nominal 2½-inch outside diameter, 3-inch outside diameter, and 4-inch outside diameter. As discussed above, the IPS 2½-inch diameter, 3-inch diameter, and 4-inch diameter nominal sizing is used in the industry. While all the FIGS. in the present disclosure illustrate a 45-degree elbow conduit EC, a 90-degree elbow conduit EC is contemplated where the 90-degree elbow conduit EC utility riser assembly URA could have larger “C” and “D” dimensions. Other elbow conduit EC degrees are also contemplated.

The foregoing disclosure and description of the present invention is illustrative and explanatory thereof, and various changes in the details of the illustrated system and apparatus and construction and the method of operation may be made without departing from the spirit of the present invention. Further, the above and other objects, features and advantages of the present invention should become even more readily apparent to those skilled in the art upon a reading of the detailed description in conjunction with the drawings, wherein there is shown and described multiple embodiments of the present invention. Furthermore, it will be apparent to those skilled in the art that various changes may be made without departing from the scope of the present invention and the present invention is not to be considered limited to what is shown and described in the specification and drawings.

We claim:

1. System configured for use with a box positioned above ground for receiving a cable, comprising:
a riser assembly having slidable riser conduits, wherein said riser conduits comprise an elbow conduit configured to transition from below ground to above ground, and a sleeve conduit configured to be expandable relative to said elbow conduit for connection with the box;
the cable running thru said riser assembly configured for connection with components in the box;
said riser assembly slidable conduits configured to move between a retracted position and an expanded position to allow varied lengths of said riser assembly for connection with the box;
said elbow conduit having a first end and a second end, said elbow conduit first end slidable within and relative to said sleeve conduit and having a maximum expansion indicator marking to indicate the maximum expansion of said sleeve conduit relative to said elbow conduit; and
a seal disposed between said riser assembly slidable conduits and between said elbow conduit maximum expansion indicator marking and said first end of said elbow conduit to operably provide a slidable seal therebetween.

2. System of claim 1, wherein said maximum expansion indicator marking is positioned on said elbow conduit to indicate the maximum expansion of said riser assembly for both during installation and after installation to maintain the structural integrity of the installed riser assembly and said slidable seal.

3. System of claim 1, wherein said riser assembly conduits are fabricated from fiberglass, and
wherein said seal is an elastomer O-ring.

4. System of claim 1, wherein said box being an electrical panel or meter box and said cable being an electrical cable, wherein said electrical cable runs inside said sealed riser assembly from below ground to inside the electrical panel or meter box for electrical connection with the components in the box.

5. System of claim 4, wherein said sealed riser assembly having an outwardly facing threaded end connector on one end of said riser assembly for mechanical connection with the box.

6. System of claim 5, wherein the other end of said riser assembly having an end connector for connection with another underground conduit, wherein after said riser assembly ends are connected, said riser assembly can retract and expand to accommodate movement after installation of said riser assembly.

7. System of claim 4, wherein said riser assembly conduits allow installation of said riser assembly without measuring, cutting or bonding a riser assembly to size relative to the box.

8. System of claim 1, wherein said seal is positioned in a groove in said elbow conduit, between the slidable riser assembly conduits, and between said maximum expansion indicator marking and said first end of said elbow conduit to provide a slidable seal therebetween.

9. Method for installing a riser assembly rising from below ground and configured to receive a cable for connection with components in a box positioned above ground, comprising the steps of:
aligning a riser assembly having slidable riser conduits below the box, wherein said riser conduits comprise an elbow conduit configured to transition from below ground to above ground, and a sleeve conduit configured to be expandable relative to said elbow conduit for connection with the box, and wherein said elbow conduit having a first end and a second end, said elbow conduit first end positioned within said sleeve conduit and having a maximum expansion indicator marking to indicate the maximum expansion of said sleeve conduit relative to said elbow conduit,
expanding said riser assembly sleeve conduit from a retracted position to an expanded position relative to said elbow conduit without expanding beyond said elbow conduit maximum expansion indicator marking for connection with the box; and
during the step of expanding said riser assembly, slidably sealing said riser assembly with a seal disposed between said riser assembly conduits and between said elbow conduit maximum expansion indicator marking and said first end of said elbow conduit.

10. Method of claim 9, wherein said maximum expansion indicator marking is positioned on said elbow conduit to indicate the maximum expansion of said riser assembly for both during installation and after installation to maintain the structural integrity of the installed riser assembly and said slidable seal.

11. Method of claim 9, wherein said riser assembly conduits are fabricated from fiberglass, and
wherein said seal is an elastomer O-ring.

12. Method of claim 9, wherein the box is an electrical panel or meter box and said cable is an electrical cable, further comprising the step of:
pulling said electrical cable inside the slidably sealed riser assembly from below ground to inside said electrical panel or meter box for electrical connection with components in the box.

13. Method of claim 9, further comprising the step of:
mechanically connecting an outwardly facing threaded end connector on one end of said riser assembly with the box.

14. Method of claim 13, further comprising the step of:
connecting a connector on the other end of said riser assembly with another underground conduit, and
after installing said riser assembly, including connecting both of said riser assembly ends, allowing said riser assembly to retract and expand to accommodate movement after installation of said riser assembly.

15. Method of claim 9, wherein said riser assembly conduits allow installation of said riser assembly without the steps of measuring, cutting or bonding said riser assembly to size.

16. Method of claim 9, further comprising the step of:
slidably sealing said riser assembly using an elastomer seal positioned in a groove in one conduit, wherein said groove is between said maximum expansion indicator marking and said first end of said elbow conduit.

17. Apparatus configured for use with an electrical panel or meter box positioned above ground, comprising:
a riser assembly having slidable fiberglass riser conduits, wherein said riser conduits comprise an elbow conduit, and a sleeve conduit configured to be expandable relative to said elbow conduit;
said riser assembly sleeve conduit having an end connector on one end and configured to move between a retracted position and an expanded position relative to said elbow conduit to allow varied lengths of said riser assembly;
said elbow conduit having a first end and a second end, said elbow conduit first end slidable within said sleeve conduit and having a maximum expansion indicator marking to indicate the maximum expansion of said sleeve conduit relative to said elbow conduit; and
an elastomer O-ring seal disposed in a groove in said elbow conduit between said first end of said elbow conduit and said maximum expansion indicator marking, and between said riser assembly slidable conduits to operably provide a slidable seal therebetween,
wherein said maximum expansion indicator marking is positioned on said elbow conduit to indicate the maximum expansion of said riser assembly for both during installation and after installation to maintain the structural integrity of the installed riser assembly and said slidable seal.

18. Apparatus of claim 17, wherein said sealed riser assembly is sized to receive an electrical cable that runs from below ground to inside the electrical panel or meter box,
wherein said sealed riser assembly having an outwardly facing threaded end connector on one end of said riser assembly for mechanical connection with the electrical panel or meter box, and
wherein the other end of said riser assembly having an end connector for connection with another underground conduit, wherein after said ends are connected, said riser assembly can retract and expand to accommodate movement after installation of said riser assembly.

19. Apparatus of claim 17, wherein the position of the maximum expansion indicator marking is engineered to anticipate the expansion after installation of the riser assembly to maintain the structural integrity of the installed riser assembly and the slidable seal.

20. Apparatus of claim 17, wherein said riser assembly slidable and expandable conduits allow installation of said riser assembly without measuring, cutting or bonding a riser assembly to size relative to the electrical panel or meter box.
